(19) United States
(12) Patent Application Publication
(10) Pub. No.: US 2008/0193817 A1
(43) Pub. Date: Aug. 14, 2008

(54) Unit cell for fuel cell, method for manufacturing thereof and fuel cell system

(75) Inventors: Sung-Han Kim, Suwon-si (KR); Yong-Soo Oh, Seongnam-si (KR); Chang-Ryul Jung, Seoul (KR); Miesse Craig, Suwon-si (KR); Hye-Yeon Cha, Seongnam-si (KR); Bo-Sung Ku, Suwon-si (KR); Jae-Hyuk Jang, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/812,662

(22) Filed: Jun. 20, 2007

(30) Foreign Application Priority Data
Feb. 14, 2007 (KR) 10-2007-0015403

(51) Int. Cl. H01M 8/04; H01M 2/14

(52) U.S. Cl. 429/30; 29/623.4; 429/36

(57) ABSTRACT

A unit cell for a fuel cell, a method for manufacturing thereof, and a fuel cell system are disclosed. With the unit cell for a fuel cell that includes a membrane-electrode assembly (MEA) including an electrolyte membrane and a pair of electrodes formed on both sides of the electrolyte membrane, a pair of plates made of plastic and attached to each other with the membrane-electrode assembly interposed, and a current collector interposed between the plate and the membrane-electrode assembly, plates made of plastic materials are attached using ultrasonic vibration, to provide a uniform pressure distribution and ensure airtightness, thereby preventing the fuel from leaking, as well as to allow smaller and thinner fuel cells.

### CROSS-REFERENCE TO RELATED APPLICATIONS

This application claims the benefit of Korean Patent Application No. 10-2007-0015403 filed with the Korean Intellectual Property Office on Feb. 14, 2007, the disclosure of which is incorporated herein by reference in its entirety.

### BACKGROUND

1. Technical Field

The present invention relates to a unit cell for a fuel cell, a method for manufacturing thereof, and a fuel cell system.

2. Description of the Related Art

The levels of power consumption have increased in small mobile devices, with the addition of various functions such as DMB and navigation, etc. Accordingly, the demand is increasing for a power source having a higher energy density than that of the lithium ion battery.

Currently, there are developments in the field of fuel cells for use in power plants, automobiles, and mobile devices, etc., among which small fuel cells are gaining attention as alternatives to lithium ion batteries in cellular phones, PDA's and laptop computers, etc. For fuel cells used in such mobile devices, it is important that the size be especially small.

In related art, the stack, which is a major part in a fuel cell, is manufactured by stacking a pair of graphite bipolar plates and a gasket and a membrane-electrode assembly interposed in-between, and joining them with bolts to a pair of end plates.

However, there is a limit to reducing the thickness of such a stack structure, because of the insufficient strength of the graphite bipolar plates, and because of the thick end plates.

Also, since bolts are used in the joining, the joining pressure is not uniform over the entire membrane-electrode assembly, so that there is a risk of leakage at the gasket.

In addition, as the performance of the stack depends substantially on the pressure or torque when applying the bolts, there is a risk of low reproducibility of the products in mass production.

### SUMMARY

An aspect of the invention is to provide a unit cell for fuel cell, method for manufacturing thereof and fuel cell system good for airtight and miniaturization by ultrasonic attaching.

One aspect of the claimed invention provides a unit cell for a fuel cell that includes a membrane-electrode assembly (MEA) including an electrolyte membrane and a pair of electrodes formed on both sides of the electrolyte membrane, a pair of plates made of plastic and attached to each other with the membrane-electrode assembly interposed, and a current collector interposed between the plate and the membrane-electrode assembly.

The plates may be made of at least one material selected from a group consisting of polycarbonate, acetal, acryl, and polyetheretherketones (PEEK), and the plates may be attached by ultrasonic vibration.

The unit cell may further include a conductive adhesive layer interposed between the membrane-electrode assembly and the current collector. Also, the unit cell may further include a gasket for preventing leakage interposed between the plate and the membrane-electrode assembly.

The current collector may include a flexible insulating layer and a conductive plating layer formed on a surface of the flexible insulating layer. Here, the conductive plating layer may be made of at least one material selected from a group consisting of gold and copper. The pair of plates may each have a ledge on an outer perimeter, where the ledges may mate together.

Another aspect of the claimed invention provides a method for manufacturing a unit cell for a fuel cell which includes loading a pair of plates and a membrane-electrode assembly such that the membrane-electrode assembly is interposed between the plates, and supplying an ultrasonic vibration to a predetermined point of the plates so that the plates are attached to each other.

The plates may be made of plastic. Also, the plates may be made of at least one material selected from a group consisting of polycarbonate, acetal, acryl, and polyetheretherketones (PEEK).

Additionally, the method may further include interposing a current collector between the plate and the membrane-electrode assembly before supplying the ultrasonic vibration to the plate. The method may also further include forming a conductive adhesive layer between the membrane-electrode assembly and the current collector.

Also, the method may further include interposing a gasket between the plate and the membrane-electrode assembly before supplying an ultrasonic vibration to the plate.

The pair of plates may each have a ledge on an outer perimeter that are configured to mate together. A welding line projected from the plate may be formed at the predetermined point of one of the plates. Here, the welding line may be formed along an outer perimeter of the plate.

Yet another aspect of the claimed invention provides a fuel cell system which includes a unit cell, a fuel supply part that supplies fuel including hydrogen to the unit cell, an air supply part that supplies air to the unit cell, and a circuit part electrically connected to the unit cell, where the unit cell includes a membrane-electrode assembly (MEA) including an electrolyte membrane and a pair of electrodes formed on both sides of the electrolyte membrane, a pair of plates made of plastic and attached to each other with the membrane-electrode assembly interposed, and a current collector interposed between the plate and the membrane-electrode assembly.

The fuel cell system may include a plurality of unit cells. The plates may be made of at least one material selected from a group consisting of polycarbonate, acetal, acryl, and polyetheretherketones (PEEK). Also, the plates may be attached by ultrasonic vibration.

The fuel cell system may further include a conductive adhesive layer interposed between the membrane-electrode assembly and the current collector. Also, the fuel cell system may further include a gasket for preventing leakage interposed between the plate and the membrane-electrode assembly.

The pair of plates may each have a ledge along an outer perimeter, where the ledges may mate together. The current collector may include a flexible insulating layer and a conductive plating layer formed on a surface of the flexible insulating layer. Also, the conductive plating layer may be made of at least one material selected from a group consisting of gold and copper.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view showing a unit cell according to an aspect of the present invention.

FIG. 2 is a cross-sectional view showing a unit cell before attachment, according to an aspect of the present invention.

FIG. 3 is a cross-sectional view showing the unit cell of FIG. 2 after attachment.

FIG. 4 and FIG. 5 are cross-sectional views showing the attachment interface of the unit cell.

FIG. 6 is a perspective view showing an ultrasonic attachment process.

FIG. 7 shows pictures of the attachment interface before and after attachment.

FIG. 8 is a flowchart showing a method for manufacturing a unit cell according to another aspect of the present invention.

FIG. 9 is a flow diagram showing a method for manufacturing a unit cell according to another aspect of the present invention.

FIG. 10 is a schematic drawing showing a fuel cell system according to yet another aspect of the present invention.

### DETAILED DESCRIPTION

The unit cell for fuel cell, method for manufacturing thereof, and fuel cell system according to certain embodiments of the invention will be described below in more detail with reference to the accompanying drawings. Those components are rendered the same reference number that are the same or are in correspondence, regardless of the figure number, and redundant explanations are omitted.

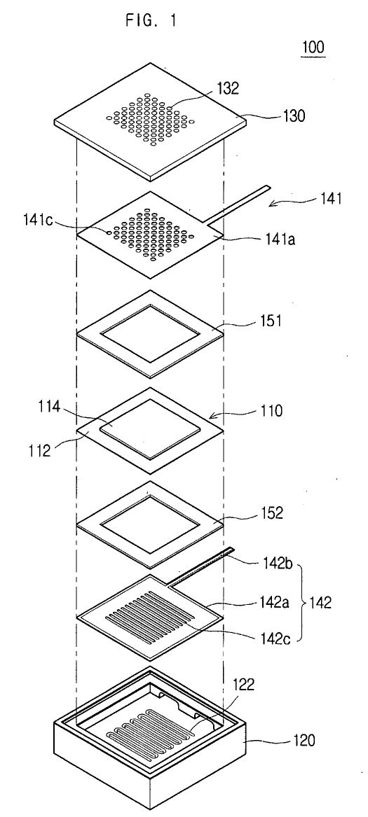

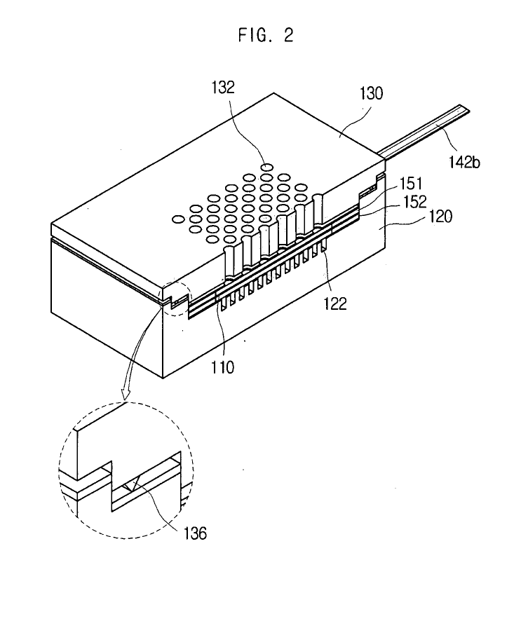

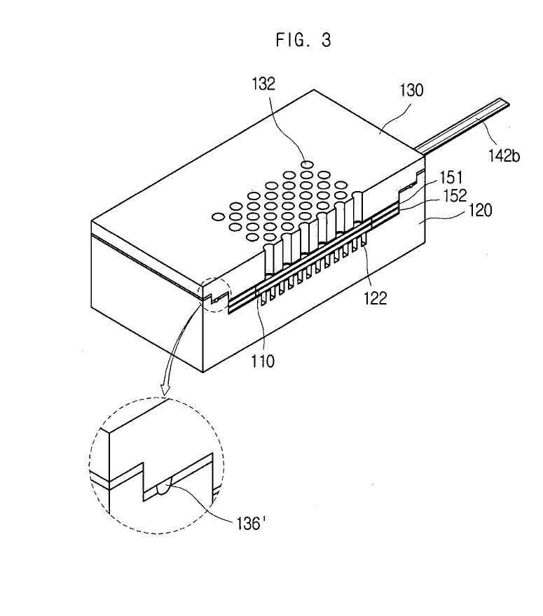

FIG. 1 is a perspective view showing a unit cell according to an aspect of the present invention, FIG. 2 is a cross-sectional view showing a unit cell before attachment according to an aspect of the present invention, and FIG. 3 is a cross-sectional view showing the unit cell of FIG. 2 after attachment. In FIG. 1 to FIG. 3 are illustrated a membrane-electrode assembly 110, an electrolyte membrane 112, a cathode electrode 114, an anode plate 120, fuel channels 122, a cathode plate 130, air channels 132, current collectors 141, 142, holes 141c, 142c, and gaskets 151, 152.

A membrane-electrode assembly (MEA) 110 may include an electrolyte membrane 112, and a cathode electrode 114 and an anode electrode (not shown) formed respectively on either side of the electrolyte membrane 112. The membrane-electrode assembly 110 may serve to substantially generate electrical currents by allowing the fuel to react with a catalyst.

In the case of a direct methanol fuel cell (DMFC), the chemical reactions that occur at each electrode may be as described below.

anode electrode: CH₃OH+H₂O→CO₂+6H⁺+6e³¹ <Reaction Equation 1>

cathode electrode: (3/2)O₂+6H⁺+6e⁻→3H₂O <Reaction Equation 2>

total reaction: CH₃OH+(3/2)O₂→2H₂O+CO₂ <Reaction Equation 3>

Electric currents may be generated by way of the above reactions, and water may be produced at the cathode electrode 114. As above described, these chemical reactions occur in a direct methanol fuel cell, and the reactions that occur at each electrode may vary according to the kind of fuel cell.

The membrane-electrode assembly 110 may be covered with a pair of separating members, that is, plates 120, 130. In this embodiment, the separating member covering the cathode electrode 114 side will be referred to as the cathode plate 130, and the separating member covering the anode electrode side will be referred to as the anode plate 120.

The anode plate 120 may be made of a plastic material, for example, polycarbonate, acetal, acryl, or polyetheretherketones (PEEK). By forming the anode plate 120 with plastic, it can be given a small size and light weight. In this way, a stack formed by stacking unit cells according to this embodiment may offer a high output of power per volume or weight, and the overall energy density (Wh/L or Wh/kg) of the fuel cell system may be increased.

Fuel channels 122 may be formed in the anode plate 120, so that fuel may be supplied to the anode electrode (not shown) of the membrane-electrode assembly 110.

If the anode plate 120 is made of plastic, the unit cell may have a current collector 141 that collects electrical charges generated at the electrodes. The current collector 141 may allow the electrical charges generated at the anode electrode to move to the cathode electrode 114 via the circuit part.

Holes 141c may be formed in the current collector 141 that correspond with the fuel channels 122 formed in the anode plate 120 so that fuel may be supplied to the anode electrode from the anode plate 120.

The current collector 141 may consist of a flexible insulating layer 141a and a conductive plating layer (not shown) formed on a surface of the flexible insulating layer 141a. By using a flexible insulating layer 141a, such as of polyimide, a unit cell of this embodiment may be made thin, and an effective electrical connection with the circuit part (not shown) may be obtained.

The conductive plating layer (not shown) formed on a surface of the flexible insulating layer 141a may be made mainly of gold or copper, which have superb electrical conductivity. By use of the current collector 141, the electrical charges generated at the anode electrode can move via the circuit part to the cathode electrode 114.

A conductive adhesive layer (not shown) may be interposed between the anode electrode of the membrane-electrode assembly 110 and the current collector 141. By placing this conductive adhesive layer (not shown) between the anode electrode and the current collector 141, the contact resistance between the two may be reduced.

Alternatively, instead of using the current collector 141 of a structure described above, a conductive adhesive metal foil may be used, which has a conductive adhesive layer (not shown) on one side and a conductive metal foil on the other side.

A gasket 151 may be interposed between the anode plate 120 and the membrane-electrode assembly 110 to for prevent leakage. This is because, as illustrated in FIG. 1 and FIG. 2, when the electrode is shaped as protruding from the surface of the electrolyte membrane 112, there is a difference in level between the electrode and the electrolyte membrane 112, which presents the possibility that the membrane-electrode assembly 110 and the anode plate 120 may not be in tight contact. Thus, it may be desirable that the gasket 151 have a depression or an opening that corresponds with the shape of the electrode. In FIG. 1 and FIG. 2, a gasket 151 is illustrated in which an opening is formed that corresponds with the shape of the electrode.

The cathode plate 130 may be a separating member that covers the cathode electrode 114 side of the membrane-electrode assembly 110, and similar to the anode plate 120 described above, may be made of a plastic material. Air channels 132 may be formed in the cathode plate 130 to supply air to the cathode electrode 114 of the membrane-electrode assembly 110.

Just as for the anode plate 120 described above, when the cathode plate 130 is formed of a plastic material, a separate current collector 142 may be equipped. The current collector 142 may allow the electrical charges generated at the anode electrode to move to the cathode electrode 114 via the circuit part, may be composed of a flexible insulating layer 142a and a conductive plating layer 142b formed on a surface of the flexible insulating layer 142a, and may have holes 142c formed therein.

As the description of this current collector 142 is the same as that set forth above, further discussions on this matter will not be provided.

In addition, a conductive adhesive layer (not shown) may be interposed between the cathode electrode 114 of the membrane-electrode assembly 110 and the current collector 142 also, in order to reduce frictional resistance.

Also, a gasket 152 may be interposed between the cathode plate 130 and the membrane-electrode assembly 110 to prevent the fuel from leaking. As the description of this matter is the same as that for the anode electrode and anode plate 120, further discussions will not be provided.

The cathode plate 130 and anode plate 120 may be attached to each other using ultrasonic vibration. For effective attachment using ultrasonic vibration, a welding line 136 may be formed on the cathode plate 130 or anode plate 120 that has a sharp tip and a protruding shape.

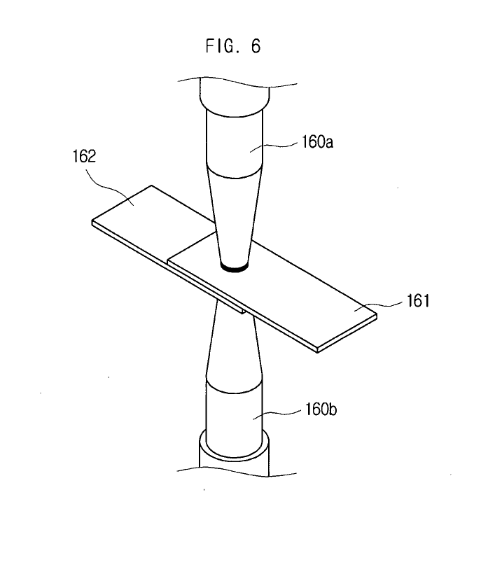

FIG. 6 is a perspective view showing an ultrasonic attachment process and illustrates how ultrasonic vibration is provided to two plates 161, 162 using an ultrasonic attachment device 160a, 160b.

As illustrated in FIG. 6, when the cathode plate 130 and anode plate 120 are placed against each other and pressure is provided while applying ultrasonic vibration using an ultrasonic attachment device 160a, 160b from the top and bottom of a position where the welding line 136 is formed, the welding line 136 and a surface touching the welding line 136 fuse together such that they are attached to each other. This method of attachment may provide airtightness, as well as sufficient attachment strength between the cathode plate 130 and anode plate 120.

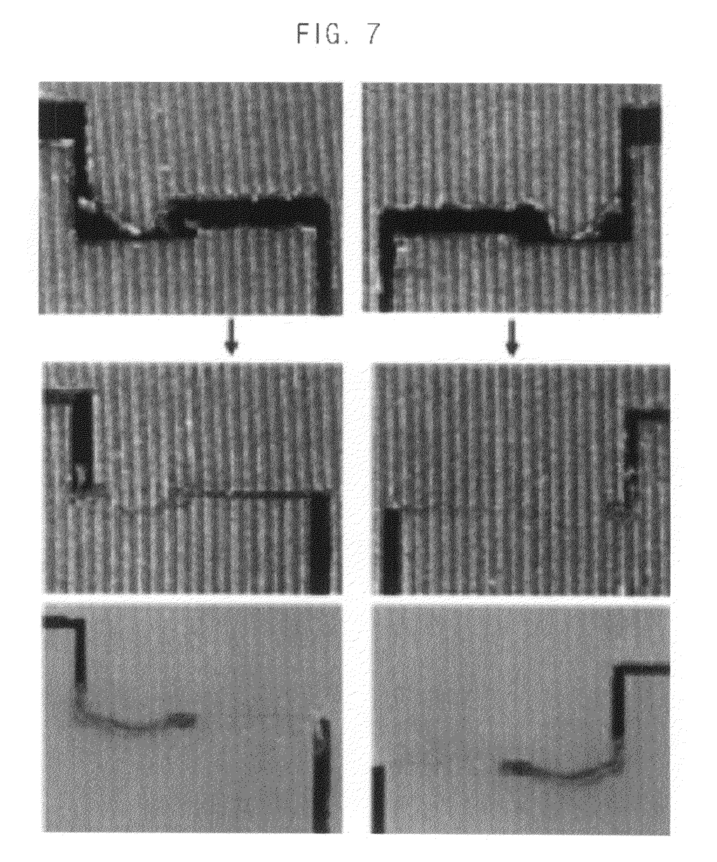

FIG. 7 are pictures showing the attachment interface before and after attachment, and in FIG. 7, it is observed how the welding line and an adjoining portion are fused together by ultrasonic vibration such that the pair of plates become attached to each other.

For tighter attachment between the cathode plate 130 and anode plate 120, the welding line 136 may be formed along the outer perimeter of the cathode plate 130 or the anode plate 120. When the welding line is formed along the outer perimeter of a plate, and ultrasonic vibration is applied on a portion where this welding line is formed, a tight attachment may be realized over the entire cathode plate 130 and anode plate 120.

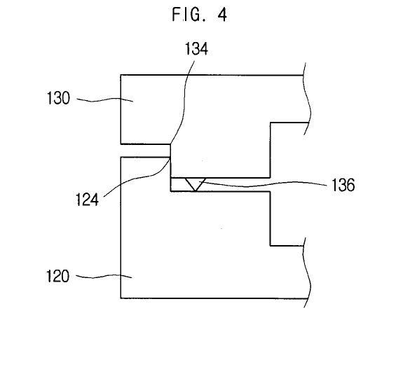

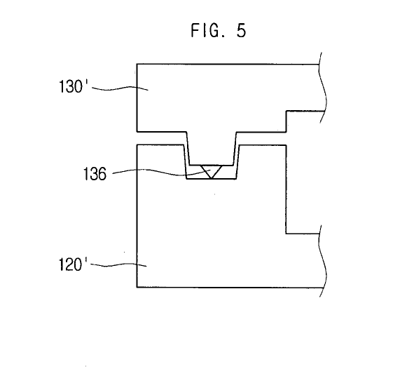

Also, as illustrated in FIG. 4 and FIG. 5, ledges 124, 134 may be formed respectively on each of the outer perimeters of the cathode plate 130 and anode plate 120 to form a mating structure. In attaching the cathode plate 130 and anode plate 120 by means of these ledges 124, 134, the cathode plate 130 and anode plate 120 may be aligned with greater ease, and the reliability of the attachment may also be improved.

The ledges may be formed once, as illustrated in FIG. 4, or may be formed twice, as illustrated in FIG. 5. Of course, the structure may vary according to design requirements.

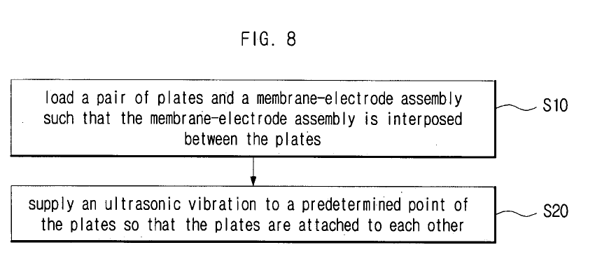

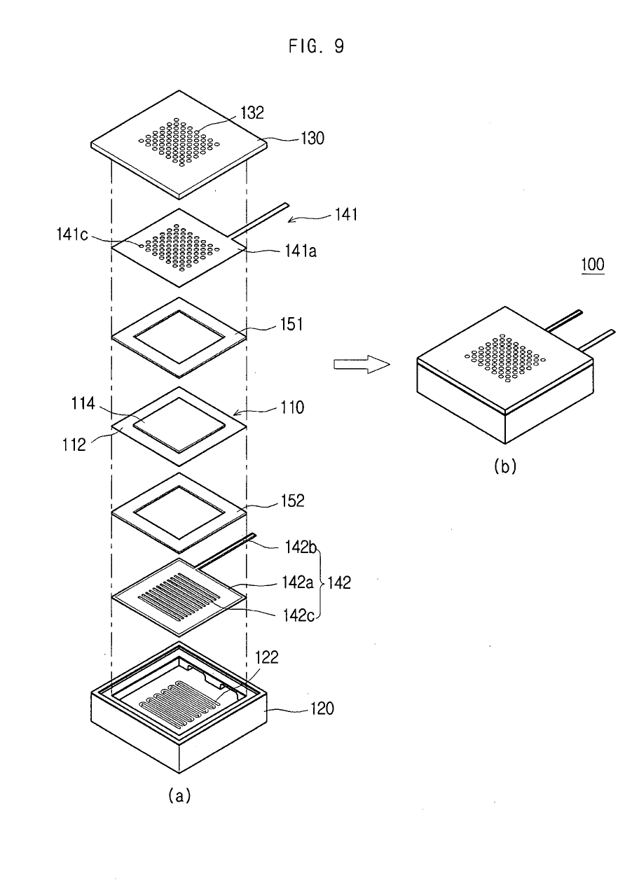

The structure of a unit cell for a fuel cell according to an aspect of the claimed invention has been described above, and now a method for manufacturing a unit cell for a fuel cell according to another aspect of the invention will be described below with reference to FIG. 8 and FIG. 9, and reference also to FIG. 1 through FIG. 7 for convenient explanation.

FIG. 8 is a flowchart showing a method for manufacturing a unit cell according to another aspect of the present invention, and FIG. 9 is a flow diagram showing a method for manufacturing a unit cell according to another aspect of the present invention. In FIG. 9 are illustrated a membrane-electrode assembly 110, an electrolyte membrane 112, a cathode electrode 114, an anode plate 120, fuel channels 122, a cathode plate 130, air channels 132, current collectors 141, 142, holes 141c, 142c, and gaskets 151, 152.

First, a pair of plates and a membrane-electrode assembly (MEA) are loaded such that the membrane-electrode assembly is interposed between the pair of plates (S10).

The membrane-electrode assembly 110 may include an electrolyte membrane 112, and a cathode electrode 114 and an anode electrode (not shown) formed respectively on either side of the electrolyte membrane 112. The membrane-electrode assembly 110 may serve to substantially generate electrical currents by allowing the fuel to react with a catalyst.

The pair of plates 120, 130 may cover the membrane-electrode assembly 110, and as described above, the separating member covering the cathode electrode 114 side will be referred to as the cathode plate 130, and the separating member covering the anode electrode (not shown) side will be referred to as the anode plate 120. As described above, fuel channels 122 and air channels 132 may be formed in these plates for the supplying of fuel and air. This is illustrated in (a) of FIG. 9.

Next, ultrasonic vibration is supplied to a predetermined position of the plates so that the plates may be attached to each other (S20). At the same time as supplying the ultrasonic vibration, a predetermined amount of pressure may also be supplied, to attach the anode plate 120 and cathode plate 130 to each other. The plates attached to each other by ultrasonic vibration are as illustrated in (b) of FIG. 9.

For effective attachment using ultrasonic vibration, a welding line 136 may be formed on the cathode plate 130 or anode plate 120 that has a sharp tip and a protruding shape, as illustrated in FIG. 2. Also, for tighter attachment between the cathode plate 130 and anode plate 120, the welding line 136 may be formed along the outer perimeter of the cathode plate 130 or the anode plate 120. As the description of such a welding line 136 is the same as that set forth above, further discussions on this matter will not be provided.

As illustrated in FIG. 4 and FIG. 5, ledges 124, 134 may be formed respectively on each of the outer perimeters of the cathode plate 130 and anode plate 120 to form a mating structure. In attaching the cathode plate 130 and anode plate 120 by means of these ledges 124, 134, the cathode plate 130 and anode plate 120 may be aligned with greater ease, and the reliability of the attachment may also be improved.

The cathode plate 130 and anode plate 120 may be made of a plastic, such as polycarbonate, acetal, acryl, or polyetheretherketones (PEEK). By forming the plates with plastic, they may be given small sizes and light weight, and also the energy consumed may be minimized in the attachment using ultrasonic vibration.

When the plates are thus made of plastic materials, current collectors 141, 142 may be interposed between the plates and the membrane-electrode assembly 110, so that there are current collectors 141, 142 equipped which collect electrical charges generated at the electrodes. The current collectors 141, 142 may allow the electrical charges generated at the anode electrode (not shown) to move to the cathode electrode 114 via the circuit part. As the description of these current collectors 141, 142 is the same as those set forth above, further discussions on this matter will not be provided.

Further, conductive adhesive layers (not shown) may be interposed between the membrane-electrode assembly 110 and the current collectors 141, 142 before attaching the plates. By thus interposing conductive adhesive layers (not shown) between the anode electrode (not shown) and the current collectors 141, 142, the contact resistance may be reduced.

In addition, to prevent the leaking of fuel, gaskets 151, 152 may be interposed between the plates and the membrane-electrode assembly 110. This is because, as illustrated in FIG. 1 and FIG. 2, when the electrodes are shaped as protruding from the surfaces of the electrolyte membrane 112, there are differences in level between the electrodes and the electrolyte membrane 112, which presents the possibility that the membrane-electrode assembly 110 and the plates may not be in tight contact.

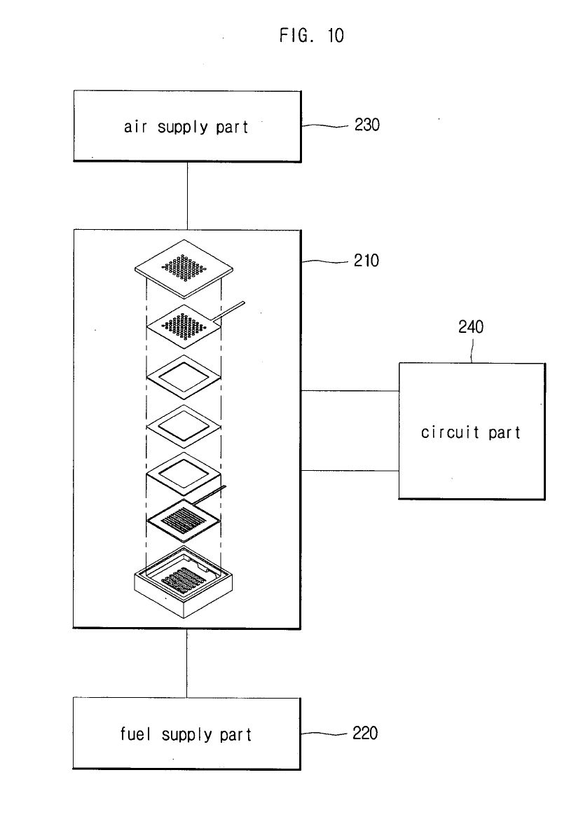

Using the unit cell for a fuel cell described above, a fuel cell system may be provided which utilizes the unit cells. FIG. 10 is a schematic drawing showing a fuel cell according to yet another aspect of the present invention. In FIG. 10 are illustrated a unit cell 210, a fuel supply part 220, an air supply part 230, and a circuit part 240.

While just one unit cell 210 may be used to generate electrical currents, a stack (not shown) may be used for increased efficiency, in which the unit cells 210 are repeatedly stacked.

The fuel supply part 220 may serve to supply fuel to the stack, i.e. the unit cells, while the air supply part 230 may serve to supply air to the stack. The circuit part 240 may be electrically connected to the current collectors of the stack to serve as a channel through which the electrical charges generated in the stack may move.

As the structure of the unit cells and the manufacturing method thereof used in a fuel cell system according to this embodiment are the same as those described above, further discussions on this matter will not be provided.

According to certain aspects of the invention as set forth above, ultrasonic attachment may be used to provide a uniform pressure distribution and ensure airtightness, thereby preventing the fuel from leaking, as well as to allow smaller and thinner fuel cells.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A unit cell for a fuel cell, the unit cell comprising:
a membrane-electrode assembly (MEA) comprising an electrolyte membrane and a pair of electrodes formed respectively on both sides of the electrolyte membrane;
a pair of plates made of plastic and attached to each other with the membrane-electrode assembly interposed; and
a current collector interposed between the plate and the membrane-electrode assembly.

2. The unit cell of claim 1, wherein the plates comprise at least one material selected from a group consisting of polycarbonate, acetal, acryl, and polyetheretherketones (PEEK).

3. The unit cell of claim 1, wherein the plates are attached by ultrasonic vibration.

4. The unit cell of claim 1, further comprising a conductive adhesive layer interposed between the membrane-electrode assembly and the current collector.

5. The unit cell of claim 1, further comprising a gasket interposed between the plate and the membrane-electrode assembly to prevent leakage.

6. The unit cell of claim 1, wherein the current collector comprises a flexible insulating layer and a conductive plating layer formed on a surface of the flexible insulating layer.

7. The unit cell of claim 6, wherein the conductive plating layer comprises at least one material selected from a group consisting of gold and copper.

8. The unit cell of claim 1, wherein the pair of plates each have a ledge on an outer perimeter, the ledges configured to mate together.

9. A method for manufacturing a unit cell for a fuel cell, the method comprising:
loading a pair of plates and a membrane-electrode assembly such that the membrane-electrode assembly is interposed between the plates; and
supplying an ultrasonic vibration to a predetermined point of the plates so that the plates are attached to each other.

10. The method of claim 9, wherein the plates are made of plastic.

11. The method of claim 9, wherein the plates comprise at least one material selected from a group consisting of polycarbonate, acetal, acryl, and polyetheretherketones (PEEK).

12. The method of claim 9, further comprising:
interposing a current collector between the plate and the membrane-electrode assembly before supplying the ultrasonic vibration to the plate.

13. The method of claim 9, further comprising:
forming a conductive adhesive layer between the membrane-electrode assembly and the current collector.

14. The method of claim 9, further comprising:
interposing a gasket between the plate and the membrane-electrode assembly before supplying an ultrasonic vibration to the plate.

15. The method of claim 9, wherein the pair of plates each have a ledge on an outer perimeter, the ledges configured to mate together.

16. The method of claim 9, wherein a welding line projected from the plate is formed at the predetermined point of one of the plates.

17. The method of claim 16, the welding line is formed along an outer perimeter of the plate.

18. A fuel cell system comprising:
a unit cell;
a fuel supply part configured to supply fuel to the unit cell, the fuel including hydrogen;
an air supply part configured to supply air to the unit cell; and
a circuit part electrically connected to the unit cell,
wherein the unit cell comprises:
a membrane-electrode assembly (MEA) comprising an electrolyte membrane and a pair of electrodes formed respectively on both sides of the electrolyte membrane;
a pair of plates made of plastic and attached to each other with the membrane-electrode assembly interposed; and
a current collector interposed between the plate and the membrane-electrode assembly.

19. The fuel cell system of claim 18 including a plurality of the unit cells.

20. The fuel cell system of claim 18, wherein the plates comprise at least one material selected from a group consisting of polycarbonate, acetal, acryl, and polyetheretherketones (PEEK).

21. The fuel cell system of claim 18, wherein the plates are attached by ultrasonic vibration.

22. The fuel cell system of claim 18, further comprising a conductive adhesive layer interposed between the membrane-electrode assembly and the current collector.

23. The fuel cell system of claim 18, further comprising a gasket interposed between the plate and the membrane-electrode assembly to prevent leakage.

24. The fuel cell system of claim 18, wherein the pair of plates each have a ledge on an outer perimeter, the ledges configured to mate together.

25. The fuel cell system of claim 18, wherein the current collector comprises a flexible insulating layer and a conductive plating layer formed on a surface of the flexible insulating layer.

26. The fuel cell system of claim 18, wherein the conductive plating layer comprises at least one material selected from a group consisting of gold and copper.
